(19) United States
(12) Patent Application Publication
(10) Pub. No.: US 2012/0255155 A1
(43) Pub. Date: Oct. 11, 2012

(54) Method for Producing a Container for a Temperature-Sensitive Operating Material, and Container for Said Material

(75) Inventors: Christoph Lind, Gleisdorf (AT); Robert Gratz, Wagrain (AT); Gregor Wasle, Reutte (AT); Paul Fletcher, Schwarzach (AT)

(73) Assignee: ALUTECH GESELLSCHAFT M.B.H., Lend (AT)

(21) Appl. No.: 13/516,109

(22) PCT Filed: Nov. 9, 2010
(86) PCT No.: PCT/AT10/00428

§ 371 Date: Jun. 14, 2012

(30) Foreign Application Priority Data
Dec. 15, 2009 (AT) A 1976/2009

(51) Int. Cl. B23P 11/00

(52) U.S. Cl. 29/428

(57) ABSTRACT

The invention relates to a method for producing a container for a temperature-sensitive operating material of a vehicle, said container having a cylindrical casing and a calotte at both ends with a cylindrical edge part, wherein a) the calotte is inserted with the convex side thereof facing inwards into the casing which is filled with a temperature-sensitive operating material and which is open on at least one side; b) the cylindrical edge part of the calotte and the part of the casing sitting thereagainst are clamped between an outer and an inner retaining block so that the retaining blocks are connected to the calotte and to the casing in a heat-conducting manner; and c) the cylindrical edge part of the calotte is welded to the part of the casing sitting thereagainst by means of a weld seam. The invention further relates to a container produced in this manner.

The present invention concerns a method for producing a container for a temperature-sensitive operating material for a vehicle. The invention further concerns a container of said kind.

Modern vehicles increasingly require temperature-sensitive operating materials, for example hydrogen, which is stored in metal hydrides, catalysts or exhaust gas treatment substances in granular or powder form, etc. They are carried in the vehicle in special containers. The requirements on such containers follow from this use: because of the reactivity of the substances, the containers must reliably remain tightly sealed, even in the case of a collision of the vehicle, which is best ensured by welding, but their contents are temperature-sensitive and therefore must not become heated during welding. In addition, such containers must be suitable for serial production.

The present invention has as an objective the creation of a container of said kind that satisfies said requirements with the lowest manufacturing costs and high process reliability. In accordance with the invention, this is achieved with a method for producing a container for a temperature-sensitive operating material for a vehicle, which container has a cylindrical casing and at each end a calotte with a cylindrical edge part, wherein

the calotte is inserted with its convex side facing inward into the casing, which is filled with the temperature-sensitive operating material and is open on at least one side,

the cylindrical edge part of the calotte and the part of the casing lying against it are clamped between an outer and an inner retaining block, so that the retaining blocks are connected to the calotte and the casing in a thermally conductive manner, and

the cylindrical edge part of the calotte is welded to the part of the jacket lying against it by means of a weld seam.

These steps can be carried out very rapidly and with high process reliability in a single device. Particular attention here should be given to the retaining blocks, which lie in a thermally conductive manner at the cylindrical edge part of the calotte and at the jacket, both on the inside and outside, which also absorb the very small amount of heat that is subsequently introduced into these parts, and thus keep it away from the temperature-sensitive operating material.

If the mass to surface area ratio of the retaining blocks is designed appropriately and takes into account the cycle time of the device, the retaining blocks can do without additional cooling. If this is not sufficient, or to minimize heat conduction, additional cooling can be provided, be it by moving the ambient air, or by feeding and withdrawing a liquid cooling agent into the interior of the retaining blocks.

Preferably, the retaining blocks are the clamping jaws of a welding device, in which a welding head is disposed so that its welding beam is aimed at the front edges of the casing and calotte. In this way, especially efficient production using a conventional welding machine is possible with minimal introduction of heat.

The manufacturing method in accordance with the invention can be carried out in two ways: either the casing is first welded to a calotte, then filled, and, after being clamped in the welding device, is then welded at the other end, where both times the method in accordance with the invention can be employed, but for the first calotte need not necessarily be employed (as long as the container still has not been filled with an operating material). Or, the casing by itself is first filled by pressing the temperature-sensitive operating agent in by rams engaging from both sides and then welding both ends by the method in accordance with the invention.

Accordingly, in a second aspect the invention also creates a container for a temperature-sensitive operating material for a vehicle, with a cylindrical casing and a calotte on both sides, where at least one of the calottes has a cylindrical edge part with significant axial extent and is disposed with its convex side facing inward, and the cylindrical edge part lies against the cylindrical casing on the inner side and is welded to it by a weld seam. The inwardly facing convex, thus inwardly curved, calotte stiffens the casing with its cylindrical edge part and provides a large spacing from the welded parts of the casing and the calottes to the temperature-sensitive contents of the container.

Preferably, the front edges of the casing and the calotte are aligned flush with each other and welded together by means of a weld seam in the form of a front seam. A front seam ensures particularly high process reliability with minimal heat input, since the welding beam hits only the front edges of the welded parts. Through this, a very thin welding bead is sufficient and, moreover, the weld lies at a maximum distance from the contents of the container. These advantages are achieved with all thermal welding processes, in particular even plasma, laser, or electron beam welding.

Alternatively, the front edges of the casing and calotte can be offset from each other in the direction of the lengthwise axis and welded together by means of a weld seam in the form of a fillet weld.

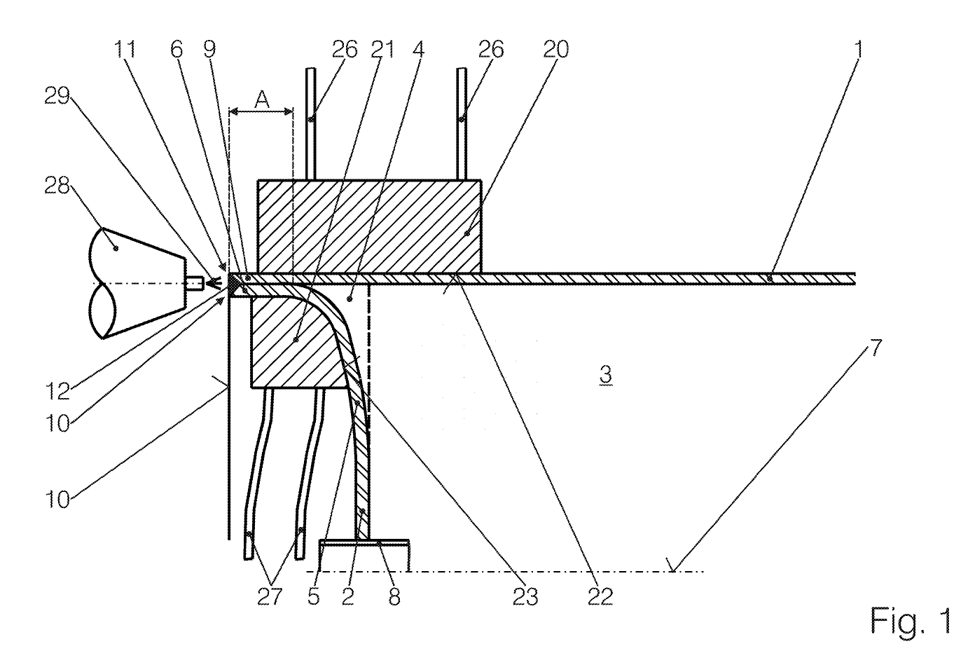

The invention is described and explained below by means of the single FIG. 1, which is a cross-sectional view of a portion of the container in accordance with the invention.

In FIG. 1 the cylindrical casing of a container is designated with the number 1 and the calotte closing one side with the number 2. “Cylinder” here is understood to mean not only a circular cylinder. At the other end, not shown, the casing 1 can be closed with a similar calotte 2 or in another way. The temperature-sensitive operating material 3 is situated within the container 1, optionally with a small air space 4.

The calotte 2 comprises a part 5 (spherical, ellipsoidal, or other), which is curved inwardly, and a cylindrical edge part 6 that joins it and extends over a significant length A in the direction of the lengthwise axis 7 of the container. The calotte 2 can have one or more orifices, pipe sleeves, nipples 8, or the like, for withdrawal of the container contents.

The cylindrical edge part 6 lies against a part 9 of the casing 1 on its inner side, specifically, preferably so that its front edge 10 is flush with the front edge 11 of the casing 1, i.e., it lies in the same axinormal plane. The weld seam 12 adjoining the two front edges 10 and 11 is then preferably, as shown, a front seam, in particular one with a small cross section.

Alternatively, the front edges 10 and 11 can be offset from each other in the lengthwise axial direction, i.e., calotte 2 is pushed further into the casing 1 or projects beyond it, in which case the weld seam 12 is preferably made as a fillet weld.

In addition, a part of the device used for the fabrication is also indicated in FIG. 1. Essentially, this is the two retaining blocks 20 and 21. The outer retaining block 20 is a ring going around the casing 1, which can also consist of individual segments that can be raised in the radial direction in order to clamp casing 1. The inner surface 22 of the retaining block 20 lies against casing 1 in a thermally conductive manner. The inner retaining block 21 is likewise a ring, which can be segmented. Its outer contour follows the inner contour of the concave side of the calotte 2 and lies against it in a thermally conductive manner. Both retaining blocks 20 and 21 are in this case cooled by a liquid, which is fed and withdrawn via lines 26 and 27.

The welding head 28 of a thermal welding device is disposed and directed so that its welding beam 29 strikes the front edges 10 and 11 of casing 1 and calotte 2 in the direction parallel to axis 6. In practice, the welding machine can also have a rotary table (not shown) with vertical axis 7 and the welding head 28 can be aimed vertically downward.

The process steps are also fully comprehensible from FIG. 1. The casing 1 is clamped in the outer retaining block 20, calotte 2 is inserted, in particular pressed in, preferably until its front edge 10 is flush with the front edge 11 of casing 1. Then the inner retaining block 21 is inserted into the calotte. Likewise, however, it is also possible first to insert the calotte 2 and then to clamp both retaining blocks 20 and 21. Then the weld seam 12 is made. In this way both calottes 2 are joined to the casing 1. The casing 1 is filled with the operating agent 3 before introducing the second calotte, at the latest.

The invention is not limited to the embodiment example that is shown, but rather comprises all variants and modifications that fall within the scope of the following claims. In particular, no limiting statements are made with regard to the raw materials.

What is claimed is:

1. A method for producing a container for a temperature-sensitive operating material of a vehicle, the container including a cylindrical casing and at each end a calotte with a cylindrical edge part, comprising:
a) inserting the calotte with its convex side facing inward into the casing, which is filled with the temperature-sensitive operating material and is open on at least one side,
b) clamping the cylindrical edge part of the calotte and the part of the casing lying against it between an outer and an inner retaining block, so that the retaining blocks are connected to the calotte and the casing in a thermally conductive manner, and
c) welding the cylindrical edge part of the calotte is welded to the part of the casing lying against it by means of a weld seam.

2. The method of claim 1, wherein the retaining blocks are cooled.

3. The method of claim 1, wherein the retaining blocks are the clamping jaws of a welding device, in which a welding head is disposed so that its welding beam is aimed at the front edges of the casing and calotte.

4. The method of claim 1, wherein the front edges of the casing and calotte are aligned flush together and are welded by means of a weld seam in the form of a front seam.

5. The method of claim 1, wherein the front edges of the casing and calotte are offset from each other in the direction of the lengthwise axis and are welded together by means of a weld seam in the form of a fillet weld.

6. The method of claim 1 any one of wherein the temperature-sensitive operating material is pressed into the casing, after which the steps (a), (b) and (c) are carried out at each side of the casing.

7. (canceled)

8. (canceled)

9. (canceled)

10. (canceled)
